(19) United States
(12) Patent Application Publication
(10) Pub. No.: US 2005/0045283 A1
(43) Pub. Date: Mar. 3, 2005

(54) Rolling door error-start prevention device

(76) Inventor: Chung Hsien Hsieh, Taipei Hsien (TW)

Correspondence Address: BUCKNAM AND ARCHER, 1077 Northern Boulevard, Roslyn, NY, 11576-1696, US

(21) Appl. No.: 10/654,334

(22) Filed: Sep. 3, 2003

(51) Int. Cl. E05F 11/00

(52) U.S. Cl. 160/189

(57) ABSTRACT

A rolling door error-start prevention device, comprising: a base plate provided at a lateral side of the upper rolling shaft accommodating chamber of rolling door; a rolling machine having a housing-base and a sprocket which drives said rolling shaft of the rolling door through a chain rolling, and which is fixed on the drive shaft; wherein said housing-base of the rolling machine is pivoted, in a swingable manner, to its upper position, at a base plate through a shaftpin, one or two slot(s) is (are) formed at a position below said base, and a guiding rod loosely passes through said slots and slidably pivots to said base; a tension spring, positioned oppositely to the direction of rotation of the rolling shaft, and applying a tension force onto lower portion of the housing-base of the rolling machine to maintain the base in a balanced condition; a sensor device, provided at the lower portion of the housing-base of the rolling machine, and used to detect the position of the base in such a manner that the sensor can switch off the power supply for a delay circuit and supply a reverse current to the rolling machine to rotate in reverse direction to cause the rolling door to descend back to its original position, when a deflection of the base due to the exceeding of torque load beyond a critical point is detected.

### BACKGROUND OF THE INVENTION

1. Field of the Invention

This invention relates to a rolling door error-start prevention device, and particularly to a device in which a sensor device switches off the power supply when a deviation of position caused by exceeding of torque load beyond a critical point is detected in the case where the rolling door is jammed with the latch pin, and then supplies a reverse current to the rolling machine, so that the rolling machine will rotate in a reverse direction to cause the rolling door to return back to its original position.

2. Description of the Prior Art

Referring to FIG. 1, for safety reason, a conventional rolling door is usually provided with a latch device 2 on one side of the rolling door 1, the purpose of which is to avoid being externally enforced opened either by a jack or by other means, after the door is closed. The latch device 2 is locked, from outside, the rolling door 1 after the door is closed. However, the latch device 2 must be unlocked at first, before the switch 3 for the rolling door 1 is switched on. In some cases, users often forget to unlock the latch device 2 before switching on the switch 3 for the rolling door 1. As a result, the rolling door 1 is jammed with the latch pin of the latch device 2, and this will result in switching on safety device and cutting-off of the power supply. In this case, neither can the rolling door 1 be opened, nor can the latch device 2 be unlocked. The only solution is to eliminate the jammed condition between the rolling door 1 and the latch device 2, i.e., the rolling door 1 must return back to its original loose status, and then the latch device 2 can be unlocked, and the switch 3 of the rolling door can be switched on again. Therefore, the design of conventional rolling door 1 still has room for improvement.

### SUMMARY OF THE INVENTION

In order to solve the jammed problem caused by error-start of the conventional rolling door, the inventor of the present invention endeavored to think out that the rolling door should have the function of self-restoration to avoid the jammed problem caused by the error-start of rolling door. Therefore, the object of present invention is to provide a rolling door error-start prevention device, in which a sensor device switches off the power supply when a deviation of position caused by exceeding of torque load beyond a critical point is detected in the case where the rolling door is jammed with the latch pin, and then by supplying a reverse current to the rolling machine, the rolling machine will rotate in a reverse direction to cause the rolling door to return back to its original position.

The above object can be achieved by the rolling door error-start prevention device of the present invention, comprising: a base plate provided at a lateral side of an upper-side rolling shaft accommodating chamber of the rolling door; a rolling machine, having a housing-base; and a sprocket which is fixed on the drive shaft, and which drives said rolling shaft of the rolling door through a chain; wherein said rolling machine is pivoted, in a swingable manner, to said housing-base through a pin on upper side of said housing-base, one or two slot(s) is (are) formed at lower position of said base, and a guiding rod loosely passes through said slots, and slidably pivots to said base; a tension spring provided in opposite direction of the rolling shaft, and applying a tension force onto lower portion of the housing-base of the rolling machine to maintain the base in a balanced condition; a sensor device provided at a lower portion of the housing-base of the rolling machine, and used to detect position of the base, so that when a deviation of position caused by exceeding of torque load beyond a critical point is detected, the sensor will switch off the power source, and then by supplying a reverse current to the rolling machine, the rolling machine will rotate in reverse direction to cause the rolling door return back to its original position.

### BRIEF DESCRIPTION OF DRAWINGS

FIG. 1 is a schematic view of a conventional rolling door;

FIG. 2 is a schematic view of an embodiment of the rolling door error-start prevention device of present invention showing that the rolling door in balanced condition;

FIG. 2a is a schematic sectional view taken along with an arrow 2a-2a in FIG. 2;

FIG. 2b is a partially enlarged view of encircled part 2b in FIG. 2;

FIG. 3 is the embodiment of FIG. 2 showing that the rolling door is in an unbalanced condition;

FIG. 3a is a partially enlarged view of encircled part 3b in FIG. 3.

### DETAILED DESCRIPTION OF THE INVENTION (PREFERRED EMBODIMENTS)

The technological features and advantages of present invention will be further understood with the description of a preferred embodiment of present invention, which is considered to be illustrative purpose only and should not be regarded as limitative, in reference to accompanied drawings.

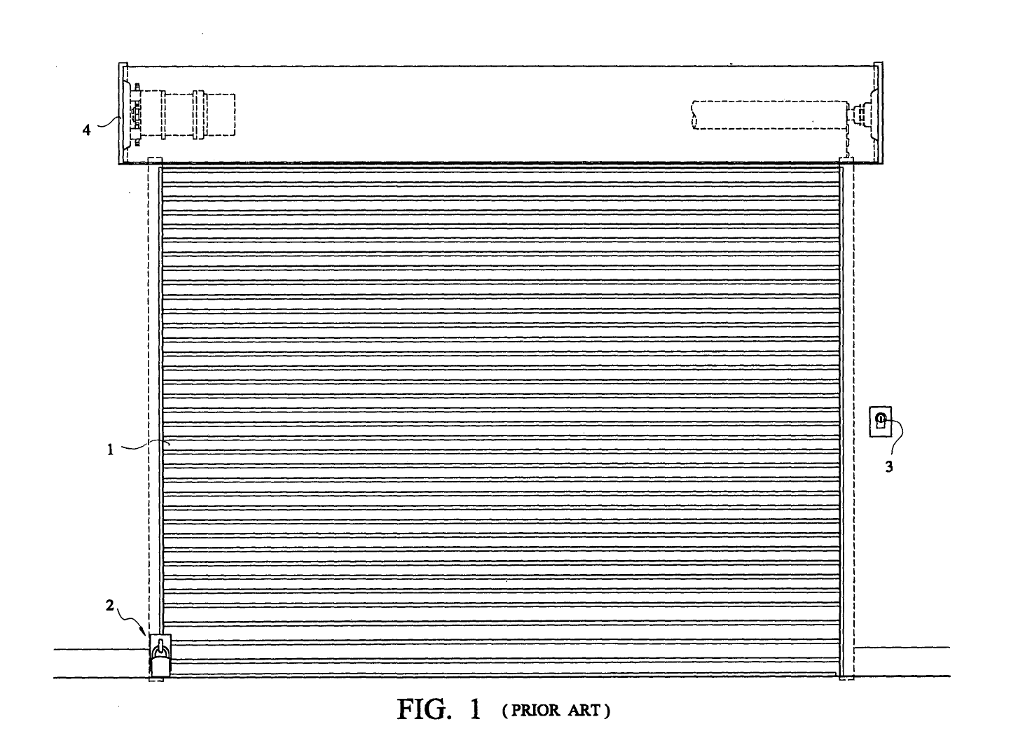

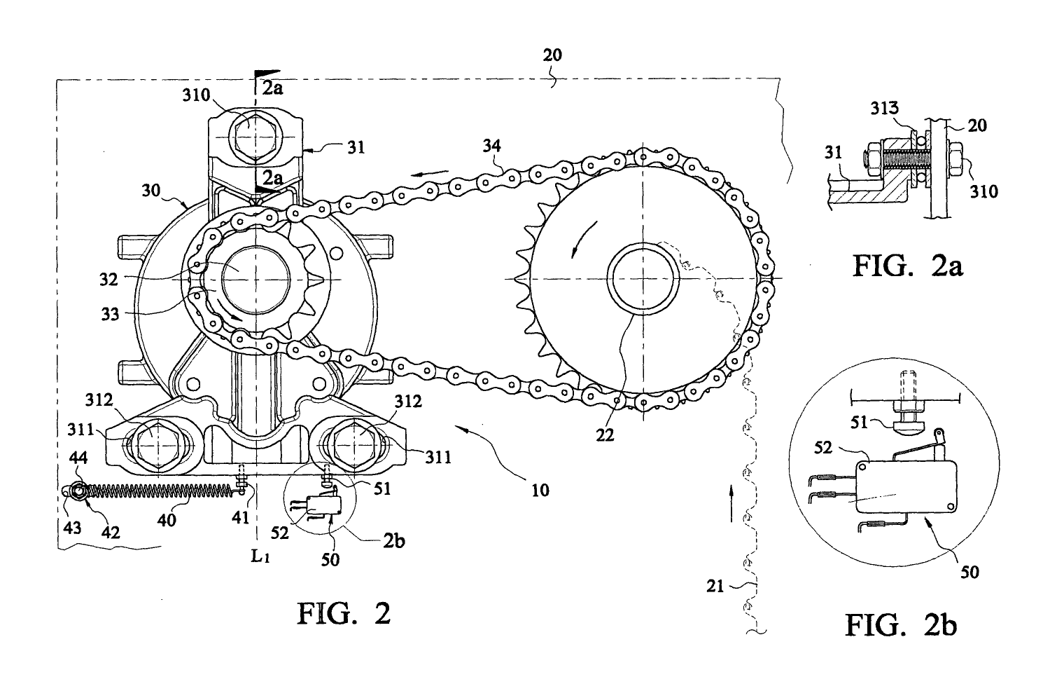

Firstly, referring to FIG. 2, a rolling door error-start prevention device 10 of the present invention comprises a base plate 20 which is provided at a lateral side of an upper-side rolling shaft 22 accommodating chamber of a rolling door 21 (the same as position of element 4 of a conventional rolling door as shown in FIG. 1).

A rolling machine 30 has a housing for receiving a power unit which can rotate a drive shaft 32. A base 31, fixed at one end of the drive shaft 32 projecting from said housing of the rolling machine 30, is used to mount the rolling machine 30 onto the base plate 20. A sprocket 33 is attached to the drive shaft 32 of the rolling machine 30, and can drive the rolling shaft 22 of the rolling door 21 through a chain 34, wherein the rolling machine 30 is pivoted, in a swinable manner, to the housing-base 31 through a shaftpin 310 on upper side of the housing-base 31. One or two slot(s) 311 is (are) formed at the lower position of the base 20. A guiding rod 312, loosely passing through said slots 311, is fixed at the base 20, and can slide in right and left direction to confine the swinging range of the base 31. In this embodiment, the shaftpin 310 is used to support the whole weight of the rolling machine 30 at an upper position of the housing-base 31. In order to make the rolling machine 30 swing smoothly within allowable range even under an unbalanced condition of torque load, a plain bearing 313 is pivotally provided at the boundary between the upper part of the housing-base 31 and the base 20 (as shown in FIG. 2a).

A tension spring 40 is provided to apply a tension force onto the lower portion of the housing-base 31 of the rolling machine 30 in a direction opposite to the rotation of the rolling shaft 22. One end of the tension spring 40 is hooked on the support member 41 below the base 31, and the other end includes a tension force adjustment device 42 which can adjust the stretched length of the spring to the effect that the force exerted on the lower portion of the base can be adjusted. In this embodiment, the tension force adjustment device 42 is a slot 43 provided on the base 20. The tension spring 40 can adjust its stretched length in the slot 43 by a threaded fastener 44, so as to maintain the base 31 with sensitivity to a balanced position of the central axis L1.

A sensor device 50, provided below the housing-base 31 of the rolling machine 30, is used to detect whether the position of the base 31 is in a balanced condition or not (as shown in FIG. 2b). The sensor device 50, for example can be a trigger-type microswitch 52 or an optical sensor (not shown). In this embodiment, only microswitch 52 is used for illustrative purpose. The sensor device 50 includes a touch element 51 opposite to the tension spring 40 and a microswitch 52 provided at an uncontacted position which can be contacted by the touch element 51.

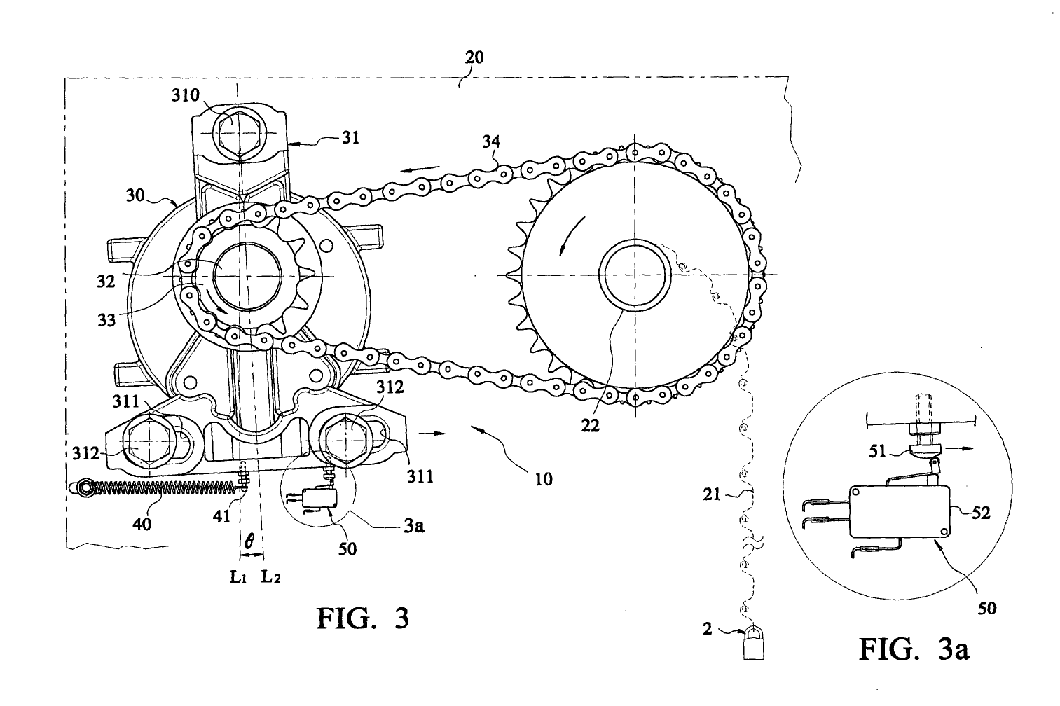

Referring to FIG. 3, a coil spring element (not shown) is inserted onto the rolling shaft 22 of the rolling door 21. The weight of the rolling door 21 can be balanced by the opposite torsional force of the coil spring element. In ideal case, the gravitational force of the rolling door 21 can be completely balanced or become negative gravitational. In other words, the opposite torsional force of the coil spring element is equal to the weight of the rolling door 21, or greater than the weight of the rolling door 21; therefore, the rolling machine 30 only needs little torsional force to rotate the rolling shaft 22 of the rolling door 21. In this case, if the rolling door 21 is jammed with the latch pin 2 due to error-start, the rotation of the rolling machine 30 will be stopped. At this moment, the torque load exceeds the critical point, so that the tension force of the tension spring 40 will have a deflection angle θ as shown in the figure. The central axis of the base 31 is located at a deflection position L2. At this time, the touch element 51 below the housing base 31 of the rolling machine 30 deflects to the contact position of the microswitch 52 (as shown in FIG. 3a). According to the embodiment, the normal close contact (NC) of the microswitch 52 is connected to the rolling door delay circuit, while the normal open contact (NO) is connected to the descend-down circuit. When the touch element 51 is located at the contact position of the microswitch 52, it will cut off the power. And then by supplying a reverse current to the rolling machine 30, the rolling machine 30 rotates in a reverse direction to cause the rolling door 21 to slide down and to return back to its original position (this kind of control device can be obtained from conventional circuit and thus omitted).

The abovementioned is a preferred embodiment of the present invention for illustrative purpose only, it should not be considered as a limitative to present invention. Any equivalent modifications and variations are considered to be within the range of present invention without departing from the spirit and scope of the appended claims. Based on the foregoing, rolling door with the rolling door error-start prevention device of present invention has the function of self-restoration even when the rolling door is jammed with the latch pin due to error-start condition. Therefore, this invention is novel in design, and has inventive steps comparing to convention device and potential feasibility in industrial application.

List of reference numerals

| | |
|---|---|
| 10 | Rolling door error-start prevention device of the |
| 11 | present invention |
| 20 | base plate |
| 21 | rolling door |
| 22 | rolling shaft |
| 30 | rolling machine |
| 31 | base |
| 310 | shaftpin |
| 311 | slot |
| 312 | guiding rod |
| 32 | drive shaft |
| 33 | sprocket |
| 34 | chain |
| 40 | tension spring |
| 41 | support member |
| 42 | adjustment device |
| 43 | slot |
| 44 | threaded fastener |
| 50 | sensor device |
| 51 | touch element |
| 52 | microswitch |

1. A rolling door error-start prevention device, comprising:
a base plate (20);
a rolling machine (30), having a housing for receiving a power unit which can make a drive shaft (32) rotate, and a sprocket (33) which is attached to the drive shaft (32), and which can drive a rolling shaft (22) of a rolling door (21) through a chain (34), wherein a base (31), fixed at one end of said drive shaft (32) projecting from said housing of the rolling machine (30), is pivoted, in a swingable manner to its upper position, at said base plate (20) through a shaftpin (310), one or two slot(s) (311) formed below said base (20), a guiding rod (312) loosely passing through said slots (311) and fixed at the base (20), to confine swinging range of the base (31).
a tension spring (40), which is positioned opposite to said rolling shaft (22), one end of which is fixed on said base (31), and the other end of which is fixed on said base plate (20) for maintaining said base (31) in a balanced position;
a sensor device (50), which is provided below said base (31) of the rolling machine 30, which is used to detect the position change of said base (31), and which cuts off a power supply to a delay circuit and then supplies a reverse current to make said rolling machine rotate in a reverse direction, so that the door descends back to its original position, when said base (31) swings due to hindering rotation of said rolling machine (30).

2. The rolling door error-start prevention device as claimed in claim 1, wherein a plain bearing (313) is provided at the boundary between upper side of said base (31) of said rolling machine (30) and said base plate (20).

3. The rolling door error-start prevention device as claimed in claim 1, wherein said tension spring (40) includes a tension force adjustment device (42) which can adjust the stretched length of said spring.

4. The rolling door error-start prevention device as claimed in claim 1, wherein said sensor device 50 includes a microswitch (52).
